(19) United States
(12) Patent Application Publication
(10) Pub. No.: US 2014/0136224 A1
(43) Pub. Date: May 15, 2014

(54) Educational Media Evidence Rating and Technology Analysis Solution

(71) Applicant: Derek Moore, South Dartmouth, MA (US)

(72) Inventor: Derek Moore, South Dartmouth, MA (US)

(21) Appl. No.: 14/081,808

(22) Filed: Nov. 15, 2013

Related U.S. Application Data
(60) Provisional application No. 61/726,759, filed on Nov. 15, 2012.

(51) Int. Cl. G06F 19/00

(52) U.S. Cl. CPC G06F 19/324
USPC 705/2

(57) ABSTRACT

A computer-implemented method includes receiving a comment to a medical study; prior to enabling storage of the comment in a data repository, transmitting, to a device used by a user who submitted the comment, a graphical user interface that prompts the user to enter an identifier that uniquely references a data repository record to a medical resource; receiving information indicative of the identifier that uniquely references the data repository record to the medical resource; verifying that the identifier references a data repository record to a medical resource; in response to verification of the identifier, storing the comment in association with the medical study in the data repository; and storing the identifier in association with the comment that is stored in the data repository, wherein the identifier provides evidence to support the comment.

### CLAIM OF PRIORITY

This application claims priority under 35 U.S.C. §119(e) to provisional U.S. Patent Application 61/726,759, filed on Nov. 15, 2012, the entire contents of which are hereby incorporated by reference.

### BACKGROUND

A medical database includes citations for medical literature from life science journals, online books, and so forth.

### SUMMARY

In general, one aspect of the subject matter described in this specification includes receiving a comment to a medical study; prior to enabling storage of the comment in a data repository, transmitting, to a device used by a user who submitted the comment, a graphical user interface that prompts the user to enter an identifier that uniquely references a data repository record to a medical resource; receiving information indicative of the identifier that uniquely references the data repository record to the medical resource; verifying that the identifier references a data repository record to a medical resource; in response to verification of the identifier, storing the comment in association with the medical study in the data repository; and storing the identifier in association with the comment that is stored in the data repository, wherein the identifier provides evidence to support the comment. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The actions include storing a rule specifying that acceptance of a comment is conditioned on (i) submission of evidence and an identifier that references the evidence, and (ii) on verification of validity of the reference; and responsive to receiving the comment, executing the rule; wherein transmitting the information for the graphical user interface that prompts the user to enter the identifier that uniquely references a data repository record to a medical resource comprises: responsive to executing the rule, transmitting the information for the graphical user interface that prompts the user to enter the identifier that uniquely references a data repository record to a medical resource. The actions include identifying evidence that is referenced by the identifier; prompting users to provide information indicative of a quality of the evidence; and generating, based on the provided information, information indicative of a rating of the evidence. The user submitting the comment has a social connection in a social graph to a user who submitted the medical study. The actions include generating data for a graphical user interface that when rendered on a display device displays a control, selection of which prompts the user to enter an identifier that references a record that provides evidence for the comment. The actions include preventing submission of the comment, prior to receipt of the identifier. The actions include detecting that the comment received is unassociated with the identifier; wherein transmitting is in response to detecting. The actions include receiving, information indicative of evidence that supports the comment. The actions include receiving evaluations of the evidence. The evidence comprises medical literature, and wherein the method further comprises: evaluating the medical literature based on the received evaluations.

### BRIEF DESCRIPTION OF THE FIGURES

FIG. 1 is a block diagram of a system for educational media evidence rating and technology analysis.

FIGS. 2, 3A, 3B, and 4 are screen images of graphical user interfaces generated by the system.

FIG. 5 is a flow chart of processes executed by the system.

FIG. 6 is a block diagram of components of the system.

### DETAILED DESCRIPTION

A system consistent with this disclosure collects data that is indicative of the collective efforts of physicians to evaluate medical literature databases (e.g., the medline database, the pubmed database, and so forth. Physicians use a physician social network to submit this information.

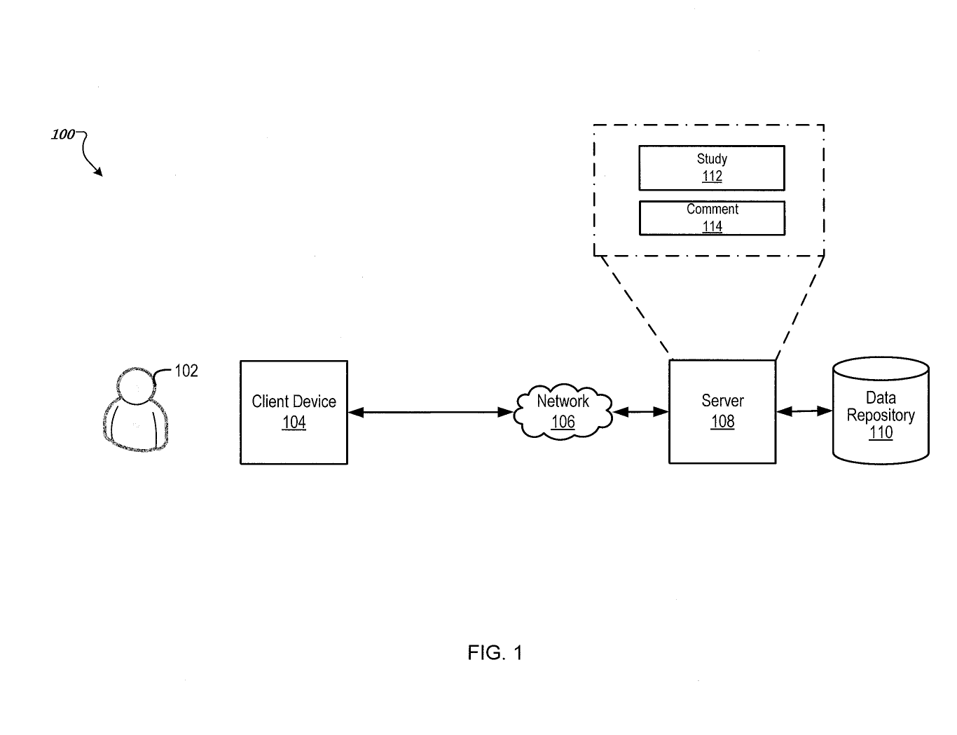

FIG. 1 is a block diagram of an example of a network environment 100 that enables an education media evidence rating and technology analysis solution. Network environment 100 includes network 106, client device 104, server 108 and data repository 110. In the example of FIG. 1, client device 104 is used by a user, including, e.g., user 102. Network environment 100 may include many thousands of data repositories, client devices, and servers, which are not shown.

In the example of FIG. 1, server 108 may be configured to implement a web server, e.g., for providing web pages and/or web sites to client device 104. In this example, server 108 generates study 112, e.g., a medical study based on questions and/or input received from users of network environment 100. In this example, user 102 wants to submit comment 114 on study 112. In this example, prior to accepting submission of comment 114, server 108 prompts user 102 to submit evidence that supports comment 114. Generally, evidence includes information supporting a statement.

In addition to prompting user 102 to submit the evidence, server 108 also prompts user to submit an identifier that references the evidence. In an example, server 108 prevents or otherwise limits submission of comment 114, e.g., until user 102 has submitted the identifier. In this example, server 108 checks if user 102 has submitted an identifier. If server 108 determines that the user has not submitted the identifier, server 108 continues to prompt user 102 to submit the identifier and only allows submission of comment 114 once the identifier has been entered.

Generally, an identifier includes a sequence of characters, numeric values, and/or non-numeric symbols, or any combination thereof, that uniquely identifies information and/or a set of identifier. There are various types of identifiers, including, e.g., a PubMed identifier (PMID). A PMID is a unique number assigned to a reference and/or a record of a resource in a database, including, e.g., the MEDLINE database of references and abstracts on life sciences and biomedical topics. A resource may include an item of data that is accessible from a network and/or a computing device. There are various types of resources, including, e.g., HTML pages, web pages, web sites, word processing documents, portable document format (PDF) documents, images, videos, audio files, electronic files, applications, medical literature and articles and so forth.

In an example, the identifier is generated by an external database (e.g., the MEDLINE database). In this example, the identifier is known to a user of the system, e.g., when the user reviews the resource in the MEDLINE database. In this example, the resource displays the identifier that is associated with the resource. In still another example, the identifier may be generated internally by the system, e.g., when the system stores resources.

In an example, server 108 implements a social network and/or a social networking service. A social network is a social structure made up of a set of actors (such as individuals or organizations) and the dyadic ties between these actors. In this example, user 102 is a user of the social network implemented by server 108. In this example, user 102 submits study 112 (e.g., a question) to server 108. In this example, other users that are social connected to user 102 in the social network may submit comments on the study, review the study, and so forth. Generally, a social connection includes a link between nodes in a social graph, wherein a node represent a particular user.

Server 108 can be a variety of computing devices capable of receiving data and running one or more services, including, e.g., an application, which can be accessed by client device 104. In an example, server 108 can include a distributed computing system, a desktop computer, a laptop, a cell phone, a rack-mounted server, and the like. Server 108 can be a single server or a group of servers that are at the same position or at different positions. Server 108 and client device 104 can execute programs having a client-server relationship to each other. Although distinct modules are shown in FIG. 1, in some examples, client and server programs can execute on the same device.

In the example of FIG. 1, client device 104 can be a variety of computing devices capable of receiving data and running one or more services, including, e.g., an application. In an example, client device 104 can include a server, a distributed computing system, a desktop computer, a laptop, a tablet, a smart phone, a cell phone, a rack-mounted server, and the like.

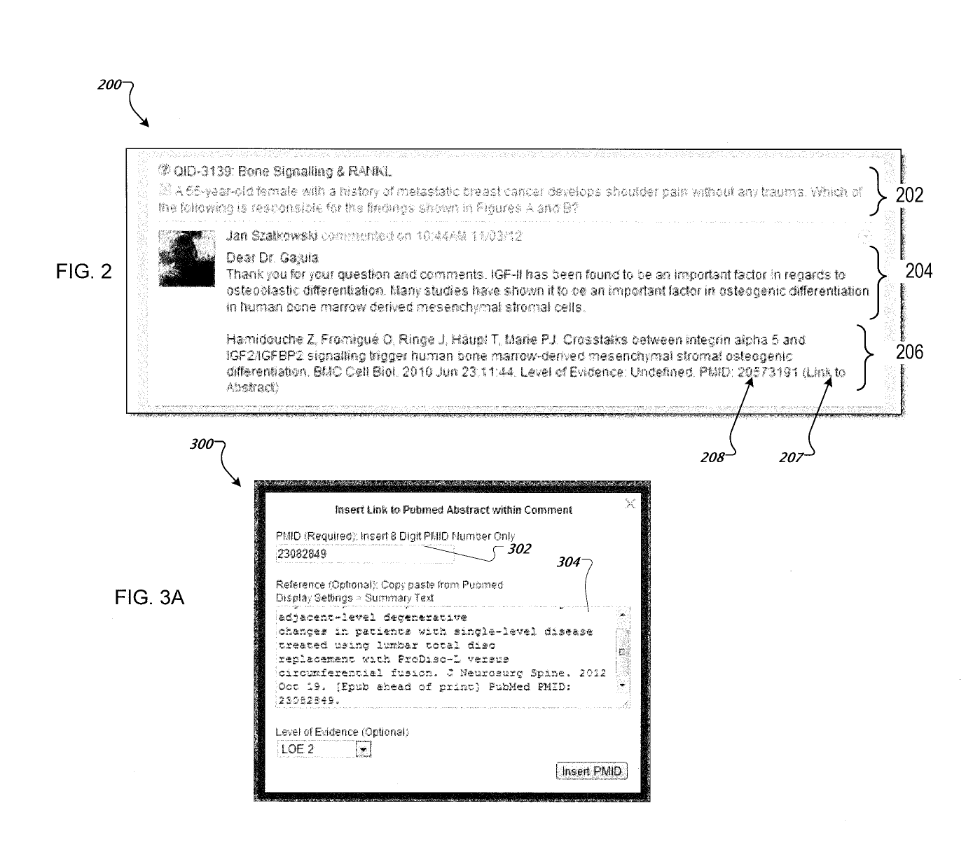

Referring to FIG. 2, server 108 generates data for graphical user interface 200, e.g., that may be rendered on client device 104. In this example, graphical user interface 200 includes portion 202 for display of a study, including, e.g., a question that was submitted to server 108 by a user of the network environment. Portion 202 is hereinafter referred to as study 202, for purposes of convenience, and without limitation. In this example, study 202 is associated with comment 204 and evidence 206. In the example of FIG. 2, evidence 206 includes PMID 208 that references a citation to the source of evidence 206. Evidence 206 includes link 207, selection of which enables a user to view an article (or other literature) that supports the evidence or is otherwise relevant to study 202. In an example, selection of link 207, causes a display (e.g., on a client device) of information (e.g., an article in the PUBMED database) that is associated with PMID 208. In an example, selection of link 207 causes a user to access the PUBMED database.

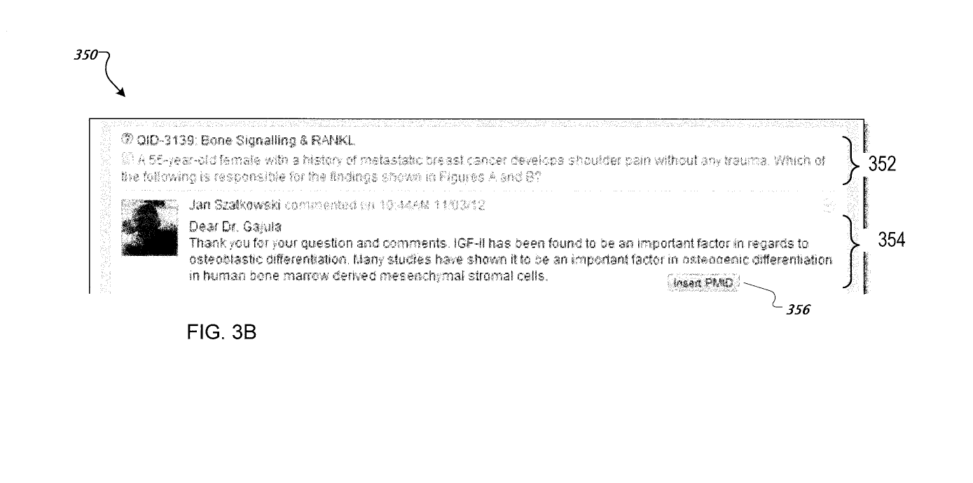

Referring to FIG. 3A, server 108 generates data for graphical user interface 300, e.g., that may be rendered on client device 104. Through graphical user interface 300, server 108 prompts a user to enter an identifier for evidence 206 that is associated with comment 204. In this example, graphical user interface 300 includes entry field 302, e.g., a field for entry of an identifier. Graphical user interface also include entry field 304, e.g., a field for entry of a summary of evidence 206.

In an example, server 108 is configured to verify the authenticity of an identifier entered into entry field 302. In this example, server 108 may be configured for communication with a data repository (e.g., data repository 110 and/or the MEDLINE database) that stores identifiers. In this example, server 108 submits to the data repository the submitted identifier along with a request to verify that the submitted identifier actually references a record in the data repository. If server 108 receives, from the data repository, an indication that the submitted identifier actually references a record in the data repository, server 108 allows the user to submit the identifier and server 108 also associates the identifier with the comment. If server 108 receives, from the data repository, an indication that the submitted identifier actually fails to reference a record in the data repository, server 108 prevents the user from submitting the comment that was associated with the identifier and prompts the user to submit a valid identifier.

In an example, data repository 110 may be configured to store various identifiers that reference various resources. In this example, server 108 may be configured to periodically crawl the Internet and/or various external data repositories to build a local repository of identifiers. In other examples, server 108 may be configured to access data repositories that are external to network environment 100, e.g., in verifying the identifiers.

In still another example, the evidence is associated with these identifiers and the user needs to determine the identifier associated with a particular piece of evidence. In an example, a piece of evidence is an item of medical literature. In this example, the item of medical literature references (e.g., displays) the identifier that is associated with the item of medical literature. By displaying the identifier, the user may review the item of medical literature and identify the identifier, e.g., to that the identifier may later be input when citing evidence (e.g., as a comment) for a study.

Referring to FIG. 3B, server 108 may also generate data for graphical user interface 350, e.g., which may be rendered by client device 104. In this example, graphical user interface 350 includes portion 352 for display of a study and portion 354 for display of a comment that a user wants to submit for the study. In this example, portion 354 also includes control 356, selection of which causes the user to be prompted to enter an identifier for a resource that provides evidence for the comment. In an example, selection of control 356 causes a display of graphical user interface 300, e.g., entry of the identifier and of the evidence that is referenced by the identifier. In an example, the graphical user interfaces displayed in FIGS. 3A and 3B enable a user to enter the types of information that are then displayed in FIG. 2.

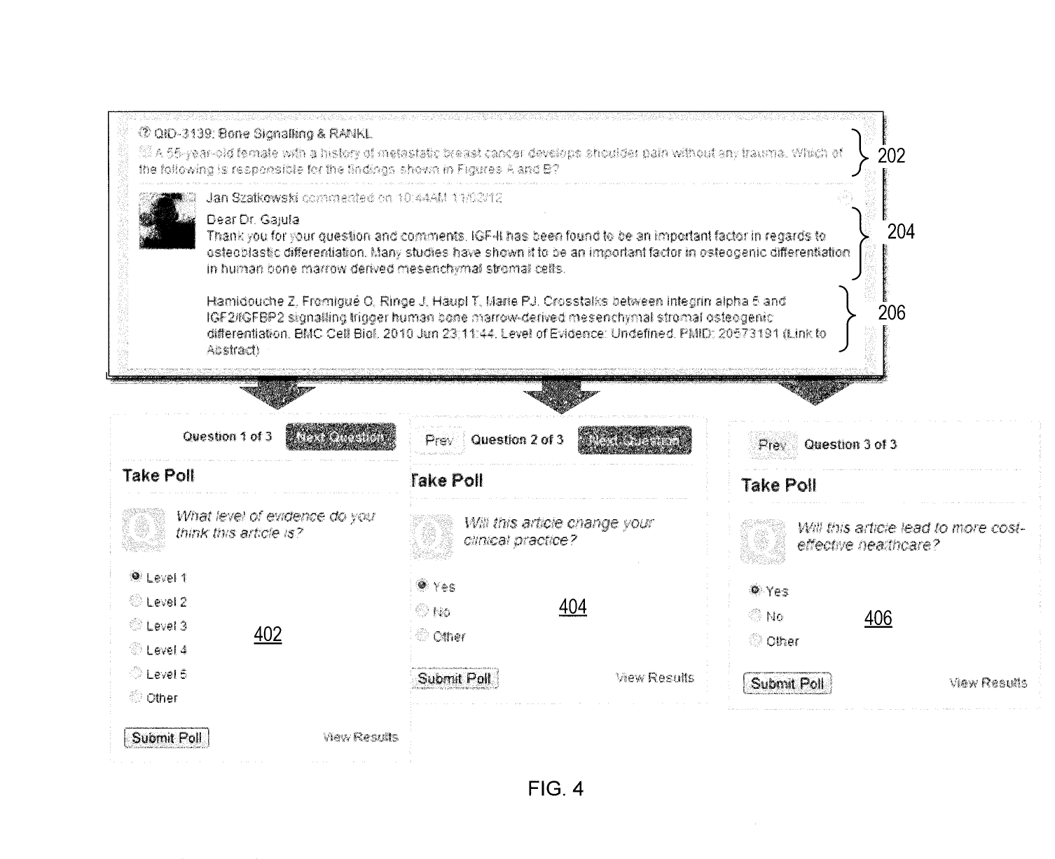

In an example, hundreds and thousands of users review comment 204 and evidence 206 that is associated with comment 204. In this example, server 108 solicits, from the users, information regarding the quality of evidence 206. Referring to FIG. 4, server 108 generates poll questions 402, 404, 406 to collect quality information, including, e.g., information that may be used in evaluating a strength and a quality of evidence 206.

In this example, server 108 collects the quality information and uses the quality information in rating the evidence, e.g., as shown in Appendix A. In an example, quality information for a particular piece of evidence is used to evaluate (e.g., rate) that piece of evidence across four different parameters, including, e.g., level of evidence, bias, clinical impact, and financial impact. In this example, quality information for a particular parameter may be weighted, e.g., based on predetermined weights. In this example, a particular item of evidence may be assigned an overall quality value, e.g., based on quality values (some of which may be weighted) for the individual parameters. Generally, a quality value includes information indicative of a rating. A quality value for an individual parameter is based on the quality information that is related to that parameter.

As shown in Appendix A, server 108 may be configured to compute a total score, a weighted score, and/or a raw score for a particular piece of evidence, e.g., a particular resource that is associated with an identifier. In an example, a total score includes a value indicate of a total number of votes counted on poll. For example, a total score may include a value indicative of a total number of responses to poll question 402. In this example, the total score may be for a particular parameter that is used in evaluating an item of evidence.

Server 108 may also be configured to generate a raw score. In this example, each answer to a poll question is associated with a value. In this example, the raw score is the average score for all the values associated with answers to the poll questions. Server 108 may also be configured to generate a weighted score. In this example, the value associated with an answer to a poll question may be weighted, e.g., based on an identity of a user who provides the answers. In an example, a user of server 108 may be associated with a user status, e.g., information indicative of a level of experience and/or skill of a user. There are various types of user statuses, including, e.g., a status of expert, a status of student, a status of fellow, and so forth.

In this example, a user specifies a user status, e.g., when the user generates an account on server 108 and/or in the social network. In this example, a particular type of user status is associated with a predetermined weighted value. For example, answers that are provided by experts may be weighted more heavily relative to the weight applied to answers that are provided by users. In this example, the weighted score incudes the raw score where individual values that are used in calculating the raw score are weighted in accordance with a user status of the user providing the answer that is associated with the value.

In an example, a particular piece of evidence may also be associated with clinical evidence, e.g., clinical results for a procedure related to the evidence. In this example, server 108 may poll users for quality information related to the clinical evidence. Using the received quality information related to the clinical evidence, server 108 generates a quality value for the clinical evidence, which may be combined with the quality values for the evidence that supports comments.

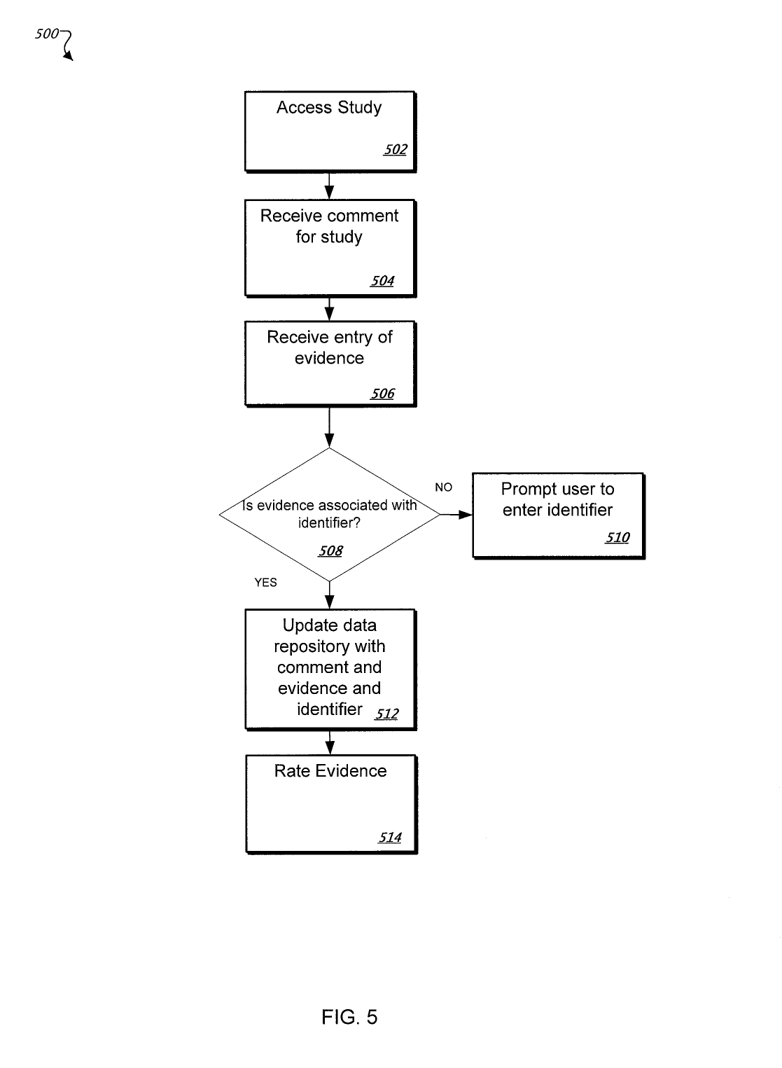

Referring to FIG. 5, server 108 implements process 400 in collecting and rating evidence. In operation, server 108 accesses (502) a study. In this example, server 108 also receives (504) a comment for the study. Server 108 also receives (506) evidence that supports the study. Upon receipt of the comment and/or the evidence, server 108 determines (508) whether the evidence and/or the comment is associated with an identifier (e.g., a PMID). If server 108 determines that the evidence and/or the comment is not associated with an identifier, then server 108 prompts (510) the user to enter an identifier that references the evidence.

If server 108 determines that the evidence and/or the comment is associated with an identifier, then server 108 updates (512) data repository 110 with the comment, the evidence and the identifier for the evidence.

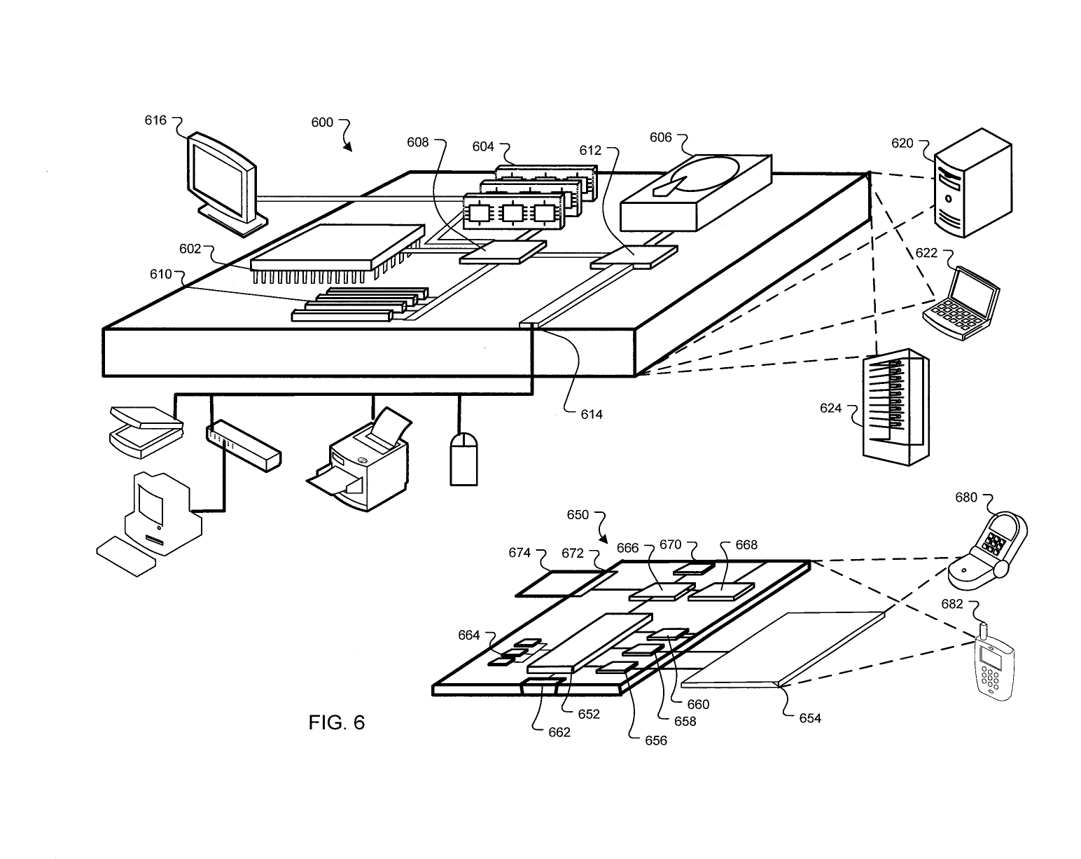

In this example, following submission of the comment to server 108—where submission of the comment is conditioned on a user who submits the comment also submitting evidence and/or an identifier for the evidence that supports a statement in the comment—server 108 may prompt other users to evaluate the evidence, e.g., by providing the other users with polling questions. Based on answers to the polling questions, server 108 rates (514) the evidence using the techniques described herein. In an example, server 108 rates the evidence, e.g., by generating a raw score and/or a weighted score for a particular parameter that is indicative of a level of quality of the evidence.

[I wouldn't use this one but rather would use a simple block diagram] FIG. 6 shows an example of computer device 600 and mobile computer device 650, which can be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 600 includes processor 602, memory 604, storage device 606, high-speed interface 608 connecting to memory 604 and high-speed expansion ports 610, and low speed interface 612 connecting to low speed bus 614 and storage device 606. Each of components 602, 604, 606, 608, 610, and 612, are interconnected using various busses, and can be mounted on a common motherboard or in other manners as appropriate. Processor 602 can process instructions for execution within computing device 600, including instructions stored in memory 604 or on storage device 606 to display graphical data for a GUI on an external input/output device, such as display 616 coupled to high speed interface 608. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

Memory 604 stores data within computing device 600. In one implementation, memory 604 is a volatile memory unit or units. In another implementation, memory 604 is a non-volatile memory unit or units. Memory 604 also can be another form of computer-readable medium, such as a magnetic or optical disk.

Storage device 606 is capable of providing mass storage for computing device 600. In one implementation, storage device 606 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, such as those described above. The data carrier is a computer- or machine-readable medium, such as memory 604, storage device 606, memory on processor 602, and the like.

High-speed controller 608 manages bandwidth-intensive operations for computing device 600, while low speed controller 612 manages lower bandwidth-intensive operations. Such allocation of functions is an example only. In one implementation, high-speed controller 608 is coupled to memory 604, display 616 (e.g., through a graphics processor or accelerator), and to high-speed expansion ports 610, which can accept various expansion cards (not shown). In the implementation, low-speed controller 612 is coupled to storage device 606 and low-speed expansion port 614. The low-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 600 can be implemented in a number of different forms, as shown in the figure. For example, it can be implemented as standard server 620, or multiple times in a group of such servers. It also can be implemented as part of rack server system 624. In addition or as an alternative, it can be implemented in a personal computer such as laptop computer 622. In some examples, components from computing device 600 can be combined with other components in a mobile device (not shown), such as device 650. Each of such devices can contain one or more of computing device 600, 650, and an entire system can be made up of multiple computing devices 600, 650 communicating with each other.

Computing device 650 includes processor 652, memory 664, an input/output device such as display 654, communication interface 666, and transceiver 668, among other components. Device 650 also can be provided with a storage device, such as a microdrive or other device, to provide additional storage. Each of components 650, 652, 664, 654, 666, and 668, are interconnected using various buses, and several of the components can be mounted on a common motherboard or in other manners as appropriate.

Processor 652 can execute instructions within computing device 650, including instructions stored in memory 664. The processor can be implemented as a chipset of chips that include separate and multiple analog and digital processors. The processor can provide, for example, for coordination of the other components of device 650, such as control of user interfaces, applications run by device 650, and wireless communication by device 650.

Processor 652 can communicate with a user through control interface 658 and display interface 656 coupled to display 654. Display 654 can be, for example, a TFT LCD (Thin-Film-Transistor Liquid Crystal Display) or an OLED (Organic Light Emitting Diode) display, or other appropriate display technology. Display interface 656 can comprise appropriate circuitry for driving display 654 to present graphical and other data to a user. Control interface 658 can receive commands from a user and convert them for submission to processor 652. In addition, external interface 662 can communicate with processor 642, so as to enable near area communication of device 650 with other devices. External interface 662 can provide, for example, for wired communication in some implementations, or for wireless communication in other implementations, and multiple interfaces also can be used.

Memory 664 stores data within computing device 650. Memory 664 can be implemented as one or more of a computer-readable medium or media (e.g., a machine-readable hardware storage device), a volatile memory unit or units, or a non-volatile memory unit or units. Expansion memory 674 also can be provided and connected to device 650 through expansion interface 672, which can include, for example, a SIMM (Single In Line Memory Module) card interface. Such expansion memory 674 can provide extra storage space for device 650, or also can store applications or other data for device 650. Specifically, expansion memory 674 can include instructions to carry out or supplement the processes described above, and can include secure data also. Thus, for example, expansion memory 674 can be provide as a security module for device 650, and can be programmed with instructions that permit secure use of device 650. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, such as those described above. The data carrier is a computer- or machine-readable medium, such as memory 664, expansion memory 674, and/or memory on processor 652, that can be received, for example, over transceiver 668 or external interface 662.

Device 650 can communicate wirelessly through communication interface 666, which can include digital signal processing circuitry where necessary. Communication interface 666 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 668. In addition, short-range communication can occur, such as using a Bluetooth®, WiFi, or other such transceiver (not shown). In addition, GPS (Global Positioning System) receiver module 670 can provide additional navigation- and location-related wireless data to device 650, which can be used as appropriate by applications running on device 650.

Device 650 also can communicate audibly using audio codec 660, which can receive spoken data from a user and convert it to usable digital data. Audio codec 660 can likewise generate audible sound for a user, such as through a speaker, e.g., in a handset of device 650. Such sound can include sound from voice telephone calls, can include recorded sound (e.g., voice messages, music files, and the like) and also can include sound generated by applications operating on device 650.

Computing device 650 can be implemented in a number of different forms, as shown in the figure. For example, it can be implemented as cellular telephone 680. It also can be implemented as part of smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method performed by one or more processing devices, comprising:
receiving a comment to a medical study;
prior to enabling storage of the comment in a data repository,
transmitting, to a device used by a user who submitted the comment, a graphical user interface that prompts the user to enter an identifier that uniquely references a data repository record to a medical resource;
receiving information indicative of the identifier that uniquely references the data repository record to the medical resource;
verifying that the identifier references a data repository record to a medical resource;
in response to verification of the identifier,
storing the comment in association with the medical study in the data repository; and
storing the identifier in association with the comment that is stored in the data repository, wherein the identifier provides evidence to support the comment.

2. The method of claim 1, further comprising:
storing a rule specifying that acceptance of a comment is conditioned on (i) submission of evidence and an identifier that references the evidence, and (ii) on verification of validity of the reference; and
responsive to receiving the comment, executing the rule;
wherein transmitting the information for the graphical user interface that prompts the user to enter the identifier that uniquely references a data repository record to a medical resource comprises:
responsive to executing the rule, transmitting the information for the graphical user interface that prompts the user to enter the identifier that uniquely references a data repository record to a medical resource.

3. The method of claim 1, further comprising:
identifying evidence that is referenced by the identifier;
prompting users to provide information indicative of a quality of the evidence; and
generating, based on the provided information, information indicative of a rating of the evidence.

4. The method of claim 1, wherein the user submitting the comment has a social connection in a social graph to a user who submitted the medical study.

5. The method of claim 1, further comprising:
generating data for a graphical user interface that when rendered on a display device displays a control, selection of which prompts the user to enter an identifier that references a record that provides evidence for the comment.

6. The method of claim 1, further comprising:
preventing submission of the comment, prior to receipt of the identifier.

7. The method of claim 1, further comprising:
detecting that the comment received is unassociated with the identifier;
wherein transmitting is in response to detecting.

8. The method of claim 1, further comprising:
receiving, information indicative of evidence that supports the comment.

9. The method of claim 8, further comprising:
receiving evaluations of the evidence.

10. The method of claim 9, wherein the evidence comprises medical literature, and wherein the method further comprises:
evaluating the medical literature based on the received evaluations.

11. One or more machine-readable hardware storage devices configured to store instructions that are executable by one or more processing devices to perform operations comprising:
receiving a comment to a medical study;
prior to enabling storage of the comment in a data repository,
transmitting, to a device used by a user who submitted the comment, information for a graphical user interface that prompts the user to enter an identifier that uniquely references a data repository record to a medical resource;
receiving information indicative of the identifier that uniquely references the data repository record to the medical resource;
verifying that the identifier references a data repository record to a medical resource;
in response to verification of the identifier,
storing the comment in association with the medical study in the data repository; and
storing the identifier in association with the comment that is stored in the data repository, wherein the identifier provides evidence to support the comment.

12. The one or more machine-readable hardware storage devices of claim 11, wherein the operations further comprise:
storing a rule specifying that acceptance of a comment is conditioned on (i) submission of evidence and an identifier that references the evidence, and (ii) on verification of validity of the reference; and
responsive to receiving the comment, executing the rule;
wherein transmitting the information for the graphical user interface that prompts the user to enter the identifier that uniquely references a data repository record to a medical resource comprises:
responsive to executing the rule, transmitting the information for the graphical user interface that prompts the user to enter the identifier that uniquely references a data repository record to a medical resource.

13. The one or more machine-readable hardware storage devices of claim 11, wherein the operations further comprise:
identifying evidence that is referenced by the identifier;
prompting users to provide information indicative of a quality of the evidence; and
generating, based on the provided information, information indicative of a rating of the evidence.

14. The one or more machine-readable hardware storage devices of claim 11, wherein the user submitting the comment has a social connection in a social graph to a user who submitted the medical study.

15. The one or more machine-readable hardware storage devices of claim 11, wherein the operations further comprise:
generating data for a graphical user interface that when rendered on a display device displays a control, selection of which prompts the user to enter an identifier that references a record that provides evidence for the comment.

16. The one or more machine-readable hardware storage devices of claim 11, wherein the operations further comprise:
preventing submission of the comment, prior to receipt of the identifier.

17. The one or more machine-readable hardware storage devices of claim 11, wherein the operations further comprise:
detecting that the comment received is unassociated with the identifier;
wherein transmitting is in response to detecting.

18. The one or more machine-readable hardware storage devices of claim 11, wherein the operations further comprise:
receiving, information indicative of evidence that supports the comment.

19. An electronic system comprising:
one or more processing devices; and
one or more machine-readable media configured to store instructions that are executable by the one or more processing devices to perform operations comprising:
receiving a comment to a medical study;
prior to enabling storage of the comment in a data repository,
transmitting, to a device used by a user who submitted the comment, information for a graphical user interface that prompts the user to enter an identifier that uniquely references a data repository record to a medical resource;
receiving information indicative of the identifier that uniquely references the data repository record to the medical resource;
verifying that the identifier references a data repository record to a medical resource;
in response to verification of the identifier,
storing the comment in association with the medical study in the data repository; and
storing the identifier in association with the comment that is stored in the data repository, wherein the identifier provides evidence to support the comment.
